(19) United States
(12) Patent Application Publication
(10) Pub. No.: US 2003/0014539 A1
(43) Pub. Date: Jan. 16, 2003

(54) System and method for traffic management

(76) Inventor: Josh L. Reznick, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/171,455

(22) Filed: Jun. 12, 2002

Related U.S. Application Data
(60) Provisional application No. 60/297,661, filed on Jun. 12, 2001.

(51) Int. Cl. G06F 15/173

(52) U.S. Cl. 709/238

(57) ABSTRACT

The invention provides system and method for tracking and managing web site user traffic. Traffic is tracked and managed in conjunction with economic factors such as contract terms governing the referral of computer users from a first web site to a second web site through the use of codes embedded in uniform resource locators (URLs). Typically, this referral is in made in conjunction with advertising or marketing efforts. Traffic may also be directed to downstream web sites in accordance with real-time economic analysis of economic factors governing the referral in order to maximize the return on advertising or marketing investments.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to traffic management systems in computer networks. The present invention also relates to dynamic linking technology, selectable creatives, and the collection and processing of marketing information.

It is known in the art that selectable banner advertisements may be used to direct a computer user from a source web page to an intermediary or destination web page. These selectable banners, for example, are often referred to as creatives. The current state of the art utilizes a static method of user redirection in which the creative is representative of a static URL address link. The link destination remains unchanged in the absence of manual manipulation (i.e. recoding) by the link administrator.

Methods are known in the art for directing a user through utilization of customized electronic advertisements. For example, U.S. Pat. No. 5,948,061 compiles statistics on individual users and networks with advertisement use tracked to permit targeting individual users. An advertising server transmits an advertisement to a user based on her profile. Also by way of example, U.S. Pat. No. 5,991,740, monitors purchases and provides referral fee accounting. A parser determines the type of advertisement that can be inserted at the position of an advertisement tag and inserts the advertisement into a page viewable in a browser.

Methods and apparatuses known to those of skill in the art have also sought to track the navigation paths of a user. For example, U.S. Pat. No. 5,717,860 discloses a method and apparatus for tracking the navigation path of a user that has been directed to a second web site from a first web site. The first site has a URL that uniquely identifies an address of the first site, and the second site has a URL that uniquely identifies an address of the second site. A composite URL is received at the second site when the user is directed from the first site to the second site. The composite URL has a first portion corresponding to the URL of the second site, and a second portion that includes information corresponding to the identity of the first site. Information representative of the identity of the first site is captured at the second site from the second portion of the composite URL. The identity of the first site is then determined at the second site by comparing information from the second portion of the composite URL to a table having a plurality of entries each of which is representative of a known site.

The current state of the art, however, fails to disclose methods or apparatuses for dynamically directing a user to a destination in accordance with specified parameters or for dynamically directing a user based on marketing information. Manual reconfiguration of a link destination is an undesirable way of directing a user to a destination. Manual reconfiguration is slow, resource intensive, and subject to unsatisfactory levels of error. There is thus a need for dynamic and automatic reconfiguration of destination information.

### BRIEF SUMMARY OF THE INVENTION

The present invention is a system and method for tracking and managing web site user traffic. Traffic is tracked and managed in conjunction with economic factors such as contract terms governing the referral of computer users from a first web site to a second web site. Typically, this referral is in made in conjunction with advertising or marketing efforts. Traffic may also be directed to downstream web sites in accordance with real-time economic analysis of economic factors governing the referral in order to maximize the return on advertising or marketing investments.

Addresses in the form of Uniform Resource Locators (URLs) are provided to referral or inventory sources which direct users to a desired web site. Each URL provided contains code, sometimes referred to as “XID™ codes”, to identify and direct a user. XID codes are used to identify information regarding a selected advertising link including, but not limited to, the link target, the referral source or publisher, a unique channel code to identify, for example, a particular sub-domain within a publisher, an insertion order code, and a creative code that may be used to identify the particular advertisement that is the source of the link. Thus, selections or “hits” made by users, e.g., by selecting a link provided to an inventory source, are associated upon referral with a significant amount of information that may be used, for example, to identify the source of a hit, and to analyze other factors associated with the traffic.

Using XID codes, all hits from a given referral source and channel are referred to a single server. At this server, the received XID code values are parsed, any desired economic analysis is performed, and the traffic is routed accordingly. Economic analysis may consist of, for example, determining the investment made by a server operator in generating the traffic or a particular subset of the total traffic received. Analysis and decision-making are conducted in real time to allow for dynamic reassessment and redirection of server traffic. Real time analysis permits users to be directed to destination web sites that allow the operator of the present invention to maximize the return on the investment made in order to receive the traffic. This mechanism further allows for continuous changes to be made during the course of marketing or advertising campaigns without the need to update URLs provided to the inventory sources.

One particular advantage of the invention over prior art systems is that analyses and decision-making processes may be made, and the rules used in making such analyses and decisions modified, at the server, without involving the referral source. Thus, interaction required from referral sources, and the possibility of errors being introduced, are significantly minimized. Moreover, traffic redirection changes may be made dynamically while remaining transparent to both the user and browser software.

The invention further includes compression and error checking procedures, and a suite of administration tools through which an operator of the present invention may change or tailor functionality of particular XID codes and, therefore, modify an advertising or marketing campaign at a level specific to the individual referral source.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting the configuration of various hardware and software components of the traffic management system, according to one embodiment of the present invention;

FIG. 2 is a flow diagram presenting a method for traffic management, according to one embodiment of the present invention;

FIG. 3 is a flow diagram continuing a method for traffic management, according to one embodiment of the present invention;

FIG. 4 is a block diagram presenting an alternative overview of the traffic redirection system, according to one embodiment of the present invention;

FIG. 5 is a screen diagram presenting an administrative tool for managing and creating traffic management identifiers and associated information, according to one embodiment of the present invention;

FIG. 6 is a screen diagram presenting an administrative tool for correlating an IO code and associated information with a traffic management identifier, according to one embodiment of the present invention;

FIG. 7 is a screen diagram presenting an administrative tool for correlating a channel code and associated information with a traffic management identifier, according to one embodiment of the present invention;

FIG. 8 is a screen diagram presenting an administrative tool for correlating a publisher code and associated information with a traffic management identifier, according to one embodiment of the present invention;

FIG. 9 is a screen diagram presenting an administrative tool for correlating a target code and associated information with a traffic management identifier, according to one embodiment of the present invention;

FIG. 10 is a screen diagram presenting an administrative tool for correlating a creative code and associated information with a traffic management identifier, according to one embodiment of the present invention;

FIG. 11 is a screen diagram presenting an administrative tool for generating a new traffic management identifier, according to one embodiment of the present invention; and

FIG. 12 is a screen diagram presenting an administrative tool to allow multiple traffic management identifiers to be viewed and managed, according to one embodiment of the present invention.

### DETAILED DESCRIPTION OF THE PREFERRED EMBODIMENTS

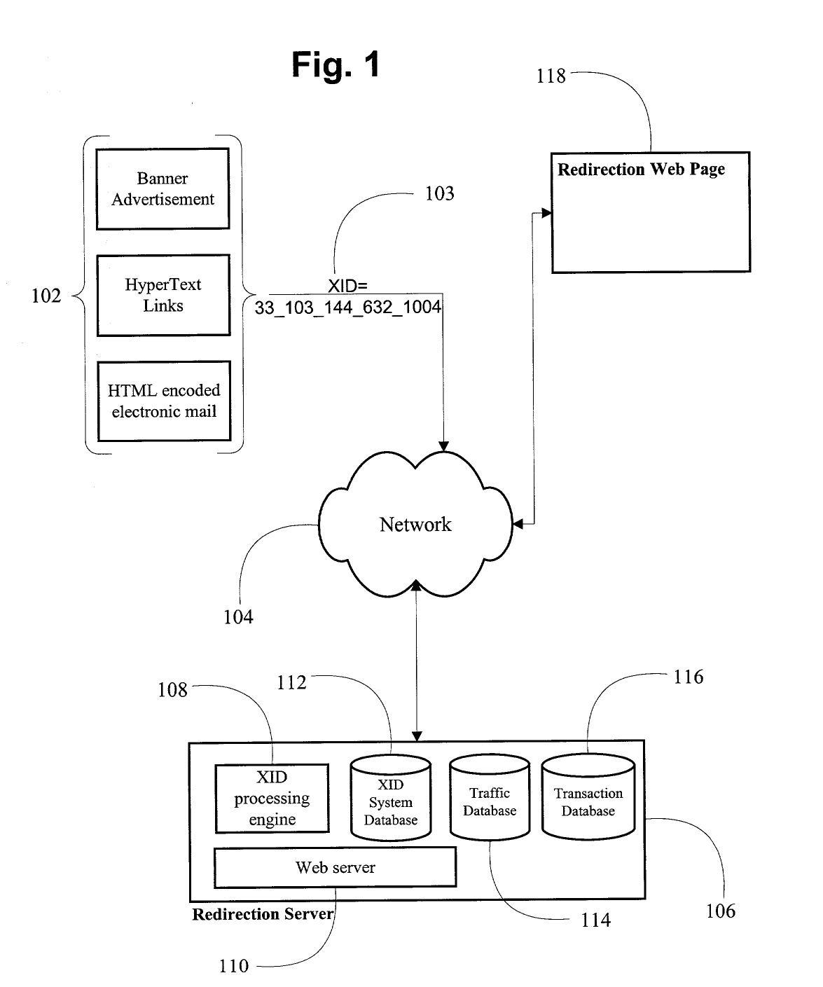

With reference to FIG. 1, one embodiment of the various hardware and software elements comprising the instant system is presented. Uniform Resource Locators (“URLs”) are provided to server operators, referred to as referral or inventory sources. The entity administering the present invention, referred to as the system administrator or administrator, typically pays a fee or otherwise arranges for the inventory sources to include the provided URLs on desired pages. These URLs are typically associated with advertising content and selection of one directs users to a desired web site. In this manner, users generate traffic from a variety of media sources 102 including, but not limited to, banner advertisements, hypertext links, and HTML encoded electronic mail.

As will be explained in greater detail herein, each URL associated with these media sources contains “XID codes” 103 to identify a media source and redirect a user in a manner that maximizes the investment made by the system administrator in obtaining the traffic. Generally, the XID code or particular portions thereof identifies the media source, the specific creative selected by the user (e.g., banner ad, text link, etc.), a target code to identify desired destination sites, and the economics involved in obtaining the traffic. When selected, this data in the form of an XID code 103 is transmitted across a network 104 to a redirection server operated by the system administrator 106.

The XID code 103 is received by the redirection server 106 and passed to the XID processing engine 108 for analysis. The XID processing engine 108 uses the data that comprises the XID code 103 to access extended information from the system database 112 about the source of the code, the economics involved in obtaining the traffic (including cost and cost type), the manner in which the user is to be redirect to a destination site, and the valid destination sites. The XID processing engine 108 completes its analysis and the user is redirected to a target web site 118 whereby the investment made by the administrator in obtaining the traffic is maximized.

The XID processing engine 108 also stores additional information regarding traffic and transaction details in the traffic and transaction databases, 114 and 116 respectively. The XID is encoded as a parameter to the Uniform Resource Locator (“URL”) that uniquely identifies the server that the XID Processing Engine is executing on. When a user selects a creative or link that is the source of the XID request, the URL of the server associated with the creative or link is accessed and passed the XID code as a parameter. For example, the URL “jump.xidserv.com?xid=33_{—}103_{—}144_{—}632_{—}1004” would access the server “jump.xidserv.com” and pass the XID processing engine executing thereon the parameter “xid=33_{—}103_{—}144_{—}632_{—}1004”. One benefit of encoding the XID codes in this manner is that it will allow full control of data tracking as well as target destination and content with minimal ongoing support from the inventory provider(s). Furthermore, so long as traffic requests received by the XID processing engine contain properly formatted XID codes, all changes to destination, content, functionality, cost analysis, etc., made be effected locally by the XID processing engine without the involvement of the referral source.

Advantageously, second level domain redirection may be used in conjunction with the XID processing engine. URLs encoded with XID codes can be ambiguous and fail to convey the redirection location of a user vis-a-vis the product that they are being redirected to. As such, these sub-domains may be used for branding purposes whereby upon processing of a received XID, the user is redirected to a sub-domain of the server executing the XID processing engine. The sub-domain may be hosted on the same server executing the XID processing engine or a physically distinct server. For example, requests to the URL “jump.xidserv.com?xid=33_{—}103_{—}144_{—}632_{—}1004” could redirect to a “branded” URLs such as “superdiscounts.xidserv.com” or “widgets.xidserv.com”.

According to one embodiment of the invention, the XID code consists of six parts or elements. A separator is used to delimit each element that comprises the XID, for example, the underscore character (“_”) or any other character that allows the elements to be easily distinguished by sight. Each element of the XID is associated with data values stored in the system database. In this manner, a large amount of information can be gleaned from simple analysis of the element value. To clarify, however, some embodiments of the XID code do not require a separator. For example, each part of the XID code could have a pre-defined number of digits. It is known in the art that a multi-part code may be parsed to obtain the code parts when the location of the parts is known.

The target code is used to associate an XID code with the targets that traffic from a particular site is redirected to. By querying the system database with a received target code, the XID processing engine is able to determine the number and address of the suitable redirection targets that traffic may be redirected to, the description of each of these redirection addresses or targets, and the manner in which the traffic redirection target is to be chosen, e.g., “mode of redirection”. Exemplary methods of redirecting traffic include, but are not limited to, fixed redirection, random redirection and optimized redirection.

Source identification elements that comprise the XID code include both a publisher code and a channel code. Each publisher code references a particular network or inventory provider, e.g., yahoo.com, and is associated with a publisher description stored in the system database. Each channel code references a particular channel within a specific publisher, e.g., travel.yahoo.com, and is unique to the publisher. Each channel code is associated with, or related to, a publisher code and a description of the channel.

Tracking both publisher and channel information allows for two-dimensional analysis of traffic data. One dimension of this analysis is the publisher code, e.g., white.com or black.com, whereas the second dimension is the channel or “sub location” within a publisher's network of diversified sites, e.g., finance.black.com or music.white.com. As will be explained in more detail herein, the XID processing engine is capable of redirecting traffic based on either the channel code, the publisher code, or both the channel and publisher codes.

This data is extremely useful in analyzing and calculating rate of return on advertising expenditures. For example, by comparing sales attributable to publishers “red.com”, “blue.com”, and “yellow.com”, an entity operating the present system and method can determine that red.com is outselling blue.com and yellow.com. By comparing sales attributable to specific channels that comprise each publisher, however, the operating entity can determine that the majority of sales are in the sports channels and that sports.blue.com is the overall leader in this channel—red.com is the overall leader only because it has small amounts of advertising attributable to several channels. The present invention, therefore, provides a higher level of data resolution than currently available systems. This two dimensional nature of the traffic is used to manage traffic redirection based on real-time analysis of the data, thereby allowing the cost involved in obtaining the traffic to be maximized.

Another element comprising the XID code is an insertion order code (“IO code”). While each IO code is unique to a publisher, each publisher can be associated with multiple IO codes.

The IO code is stored in the system database and associated with information that allows the XID processing engine to perform its cost calculations in order to maximize the investment made to purchase the received traffic. Associated information includes the media type (e.g., banner, text, email, etc.), a description, cost, and cost type. Cost type takes one of the following values: CPA (cost per acquisition), CPC (cost per click), or CPM (cost per thousand impressions). As will be explained in greater detail herein, the cost type will instruct the XID processing engine as to the proper algorithm to use when traffic redirection is optimizing. The cost value is the cost incurred in receiving the traffic and is used by the XID processing engine in determining the optimal server to redirect traffic to.

The final element comprising the XID code is a creative code. The creative code is used to store detailed information regarding a particular creative. The creative code is associated with a product identifier that uniquely identifies the product or service that the creative represents, a description, the creative media type (e.g., banner, checkbox, EPU, email, text link, other, etc.). The creative code may also be related to “creative group” data in order to create clusters of creatives. Storing this data helps facilitate testing the relative performance of comparable pieces of creative.

The XID code presents an open and flexible solution to traffic management and redirection. Additional elements can be optionally added to the standard XID code to allow additional aspects of redirected traffic to be managed and analyzed. For example, certain unique situations dictate that the inventory source retain some degree of control in the redirection process. In these cases, additional elements are added to the XID code to indicate a redirection site preferred to the inventory source that should be weighted higher than other redirection targets associated with the XID. Another situation would be where the inventory source wants to collect or log data to a particular server regarding where traffic that they are supplying is being redirected. In this case, an additional element is added to the XID code to associate the code with a server address for redirection logging. As these examples illustrate, additional elements can be freely added to the XID code to allow for enhanced or specialized functionality beyond that provided by the standard XID code elements.

The XID system may also take advantage of compression and error checking techniques to maximize use of the system's data processing resources. The compression and error checking scheme safeguards against tracking and storing incorrect or “dirty” data. In order to accomplish this, the XID code is compressed according to a base62 algorithm into a fixed length alphanumeric code, complete with a simple checksum identifier. A checksum is a value used to ensure data is stored or transmitted without error. It is created by calculating the binary values in a block of data using some algorithm and storing the results with the data. When the data is retrieved from memory or received at the other end of a network connection, a new checksum is computed and matched against the existing checksum. A non-match indicates an error. Just as a check digit tests the accuracy of a single number, a checksum tests a block of data. An exemplary fixed length format would be as follows:

XID identifier=1 characters (0-61)

Target code=3 characters (0-238327)

Publisher code=3 characters (0-238327)

Channel code=2 characters (0-3843)

IO code=3 characters (0-238327)

Creative code=3 characters (0-238327)

Checksum=2 characters (0-3843)

For example, the XID code 33_{—}103_{—}144_{—}632_{—}1004, compressed according to a base62 compression algorithm would produce the following result: XID=WOa2FB3aw05je30c. The compressed XID code is transmitted from the inventory source and converted back to base10 format by the XID processing engine where the code and associated traffic information is manipulated and stored. The base62 format, when employed, is used solely for data transfer purposes from the inventory source to the XID processing engine.

The compressed XID code is a shortened equivalent of the base10 XID code and minimizes the room for errors to be introduced into the XID code due to breakage of links, word wraps, fixed row lengths, human error on the part of the inventory source, etc. Additionally, the checksum is computed and matched against XID code upon receipt by the XID processing engine. If the two do not match exactly, an entry is made in an error log recording the time, date, XID code, referring URL if available, and IP address of the referral source if available. Additionally, an email alert may be transmitted to the system operator altering him or her to the received error so that the appropriate action may be taken.

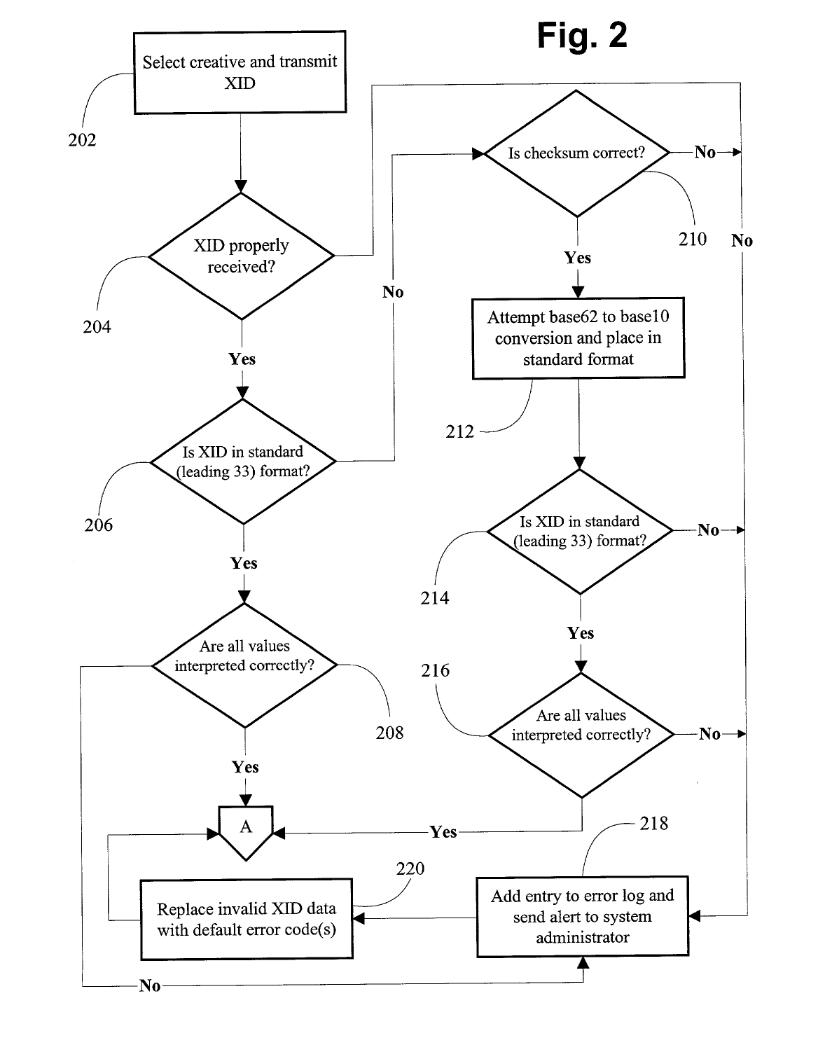

FIG. 2 presents a method for operating the system presented in FIG. 1 and the accompanying text. Web sites or other interactive media sources contain at least one creative that is advertising goods and/or services that are of interest to the user accessing the information source. When a creative of interest is identified by the user, it is selected through the use of an input device, such as a mouse. This selection causes the URL associated with the creative to be accessed and the XID code associated with the creative to be transmitted across the network, where it is received by the XID processing engine executing on the server identified by the URL, step 202. Upon receipt, the XID processing engine performs an initial check to determine if the XID code was properly received, step 204. If this check fails, an entry is added to the system's error log and an optional alert is transmitted to the system administrator identifying pertinent information regarding the failed transaction, step 218. The malformed, invalid, or otherwise improperly received XID code is replaced with a set of default XID information, step 220, and normal processing continues.

Where the check determines that the XID is properly received, the XID processing engine performs a secondary check to determine if the XID code is in the standard (base10) format, step 206. If the XID code is in standard format, a third check is performed to determine if all values or elements that comprise the XID code are correct. If so, processing continues. If not, an entry is added to the system's error log and an optional alert is transmitted to the system administrator identifying pertinent information regarding the failed transaction, step 218. The malformed, invalid, or otherwise improperly received XID code is replaced with a set of default XID information, step 220, and normal processing continues.

If the received XID code is not in standard format, step 206, the XID processing engine calculates the checksum for the received code, step 210. If the checksum is incorrect, an entry is added to the system's error log and an optional alert is transmitted to the system administrator identifying pertinent information regarding the failed transaction, step 218. The malformed, invalid, or otherwise improperly received XID code is replaced with a set of default XID information, step 220, and normal processing continues. If the checksum is valid, the XID processing engine attempts to convert the compressed base62 XID code into the standard base10 format, step 212.

Where the decompressed base10 XID is in standard format, step 214, a check is performed to determine if all values or elements that comprise the XID code are correctly formed, step 216. Where either steps 214 or 216 fail, an entry is added to the system's error log and an optional alert is transmitted to the system administrator identifying pertinent information regarding the failed transaction, step 218. The malformed, invalid, or otherwise improperly received XID code is replaced with a set of default XID information, step 220, and normal processing continues.

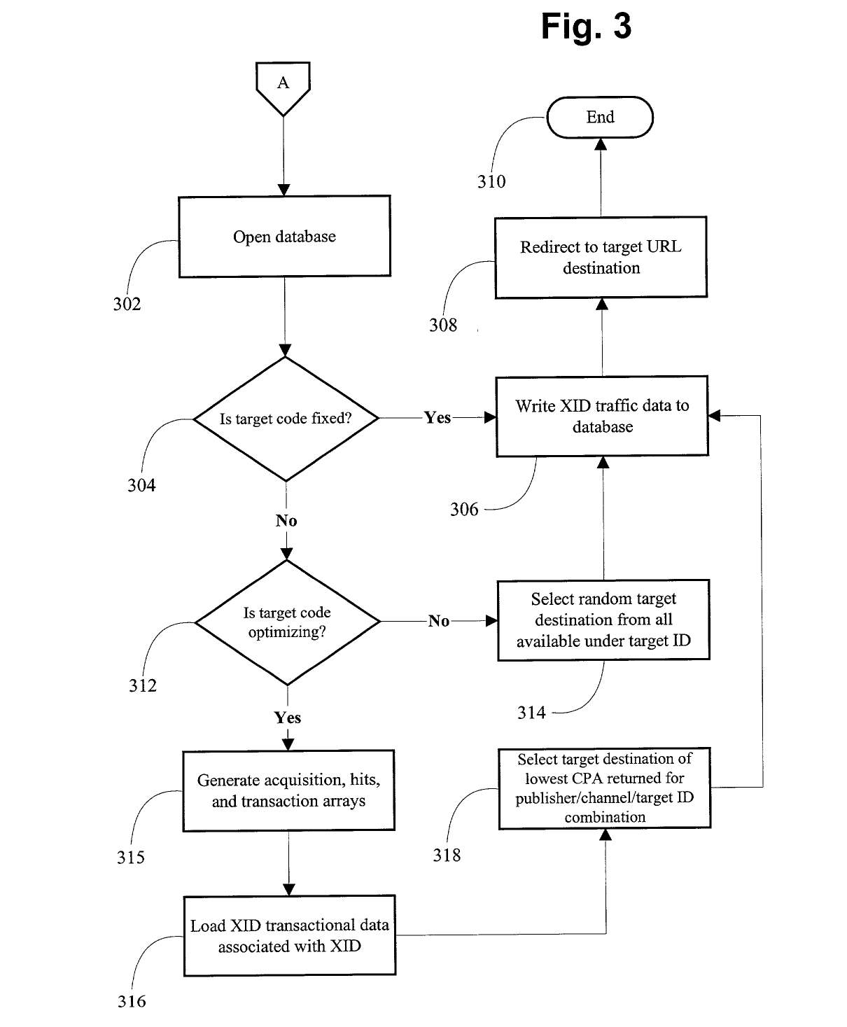

Turning to FIG. 3, after initial validation of the received XID code, processing continues to determine the ultimate location that the user is going to be redirected to. Connections are opened by the XID processing engine to the system, transaction, and traffic databases, step 302. The target code is used to query the system database to determine the mode of redirection for the received XID code. As described above, the target code is either fixed, random, or optimized. Where the traffic code is fixed, step 304, the traffic data associated with the received XID is written to the traffic database, step 306. The target URL associated with the XID's target code and stored in the system database is retrieved and the user is redirected to the target URL destination, step 308. Upon redirection, processing ends, step 310.

If the mode of redirection associated with the received target code is not fixed, a check is performed to determine if the mode of redirection is optimizing, step 312. An acquisition array is created in memory equal in length to the number of redirection target URLs associated with the XID code that is currently being processed, step 315. Simultaneously, arrays of identical length are created to temporarily store the hits and transactions for each of the redirection target URLs, step 315. The hits and transaction arrays are then loaded with the appropriate data retrieved from the traffic and transaction databases, step 316. Once the data is loaded into the arrays, a redirection target is selected from the list of redirection targets associated with the received XID code such that the investment made in acquiring the received traffic is maximized, step 318.

The cost type associated with the received XID, via the XID's IO code, determines the algorithm that is employed in determining the optimal redirection URL. As described above, three cost types are supported by the XID processing engine: cost per acquisition, cost per click, or cost per thousand impressions. For the first cost type, cost per acquisition, traffic is paid only when the user being redirected concludes a transaction after redirection. For this cost type, each element in the acquisition array is loaded with the cost per unit of traffic as defined by the IO code.

When the cost type of the traffic is based on a cost per click (CPC) formula, the following algorithm is executed by the system:

Acq[X]=((Hits[X]*Cost)/Trans[X])

In the above-defined algorithm, the hits array (Hits[X]) is the total user visits to the current target URL by the same XID as provided by the information stored in the traffic database, while the transaction array (Trans[X]) is the total transactions on the current target URL by the same XID as provided by the information stored in the transaction database. Querying the system database with the IO code extracted from the XID code retrieves the value of the variable “cost”. The CPC algorithm is executed in a loop, with one iteration executed for each URL associated with the target code provided by XID currently being processed. Upon completion of the loop, the acquisition array is loaded with the cost of redirecting traffic to each target URL.

Where the cost type of the traffic is based on a cost per thousand impressions (CPM) formula, the following algorithm is executed by the XID processing engine:

Acq[X]=((((Hits[X]/(CTR/100))/1000)*cost)/Trans[X])

An “impression” is defined as a creative, or other form of advertisement that is presented to a user, regardless of whether it is selected. As in the cost per click algorithm, the hits array (Hits[X]) is the total user visits to the current target URL by the same XID as provided by the information stored in the traffic database, while the transaction array (Trans[X]) is the total transactions on the current target URL by the same XID as provided by the information stored in the transaction database. The value of the variable “cost” is also retrieved in an analogous manner. The additional variable presented by this algorithm “CTR” refers to “Click Through Rate”, which refers to the percentage of people that see an advertisement and actually select it. Because this value is impossible to determine without significant additional information provided by the inventory sources, it is entered manually by the system administrator and may be modified as needed. Alternatively, an inventory source may set up a dedicated data feed to the system to automatically update this value. The CPM algorithm is executed in a loop, with one iteration executed for each URL associated with the target code provided by XID currently being processed. Upon completion of the loop, the acquisition array is loaded with the cost of redirecting traffic to each target URL.

The cost type is identified, the acquisition array is generated and loaded with data for each of the target URLs that is associated with the received XID code. The acquisition array is analyzed to determine the optimal redirection target URL. A variable “Y” is set and loaded with an arbitrarily large numeric value, e.g., 9999999. A second variable “Z” is also set to hold the index of the URL from the acquisition array that the user is to be redirected. The acquisition array is then looped through and the following logic applied:

If (Acq[X]<Y) and (Acq[X]>O) then Z=X and Y=Acq[X]

The result of looping through the acquisition array and applying the above-defined logic is that the variable “Z” is set to the index of the acquisition array that is the optimal target to which the traffic is redirected. The actual target URL is then extracted from the acquisition array through reference to the array index indicated by the variable “Z”.

The optimal redirection target URL is selected by applying the appropriate redirection algorithm based on the cost type of the received traffic, step 318, and the traffic data is recorded in the traffic and transaction databases, step 306. The user is redirected to the target URL selected by the XID processing engine, step 308, and processing is complete, step 310.

Where the mode of redirection associated with the received XID code is neither fixed, step 304, nor optimizing, step 312, a random redirection target is selected, step 314. The XID processing engine selects the redirection URLs associated with the target code extracted from the received XID code, step 314. One redirection URL is randomly chosen from the list of possible redirection URLs using one of any number of redirection algorithms well known to those skilled in the art. A redirection URL is randomly selected and the traffic data is recorded in the traffic and transaction databases, step 306. The user is redirected to the target URL selected by the XID processing engine, step 308, and processing is complete, step 310.

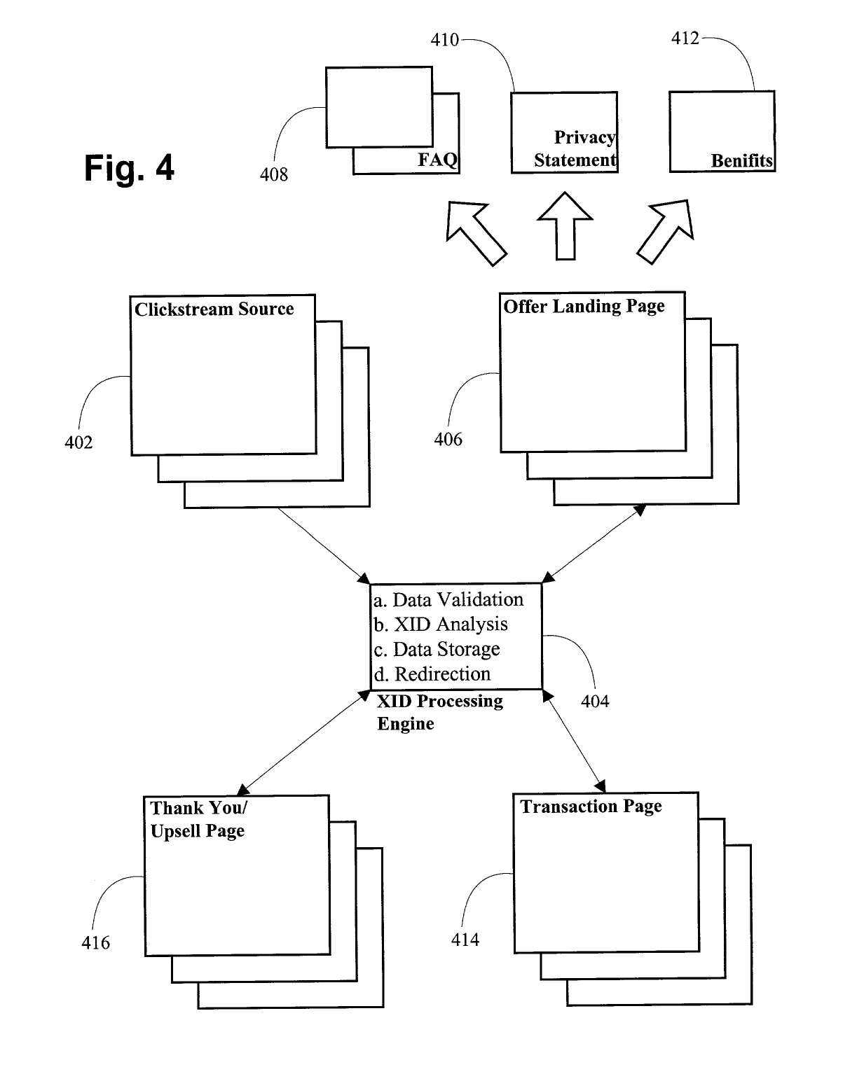

FIG. 4 is a block diagram presenting an alternative overview of the XID traffic redirection process. A user selecting interactive content such as textual links, banner advertisements, or the like generates a clickstream source 402. XID codes integrated into the interactive content are received by the XID processing engine 404 where several steps are executed. The received XID code is parsed and its data validated against data stored in the system database 404a. The XID data is analyzed to determine the mode of redirection and the appropriate algorithm that is to be used to determine the redirection target URL 404b. The redirection URL is determined and the related traffic data stored in the traffic database 404c. The user is then redirected to the target URL 404d.

Upon redirection, an “offer landing page” is presented to the user 406. On the offer landing page 406, the user is presented with a series of links that provide ancillary information regarding the offer. These links can include, for example, Frequently Asked Questions regarding the offer 408, a privacy statement 410, benefits information 412, or other information regarding the offer. If the user accepts the offer, selecting a link on the offer page (not pictured) indicates acceptance. XID data is transmitted back to the XID processing engine 404 for recordation and the transaction page is loaded into the user's content viewing software, e.g., web browser 414. The user interacts with the transaction page to finalize purchase of the offer, typically by providing credit or debit information to allow for payment of the offer. This transaction data is also sent back to the XID processing engine 404 for recordation in the transaction database and is used in calculating cost per acquisition (CPA) data. Upon completion of the transaction, the user is presented with a thank you page 416 that thanks the user for their purchase of the offer. Optionally, the user is presented with an upsell page.

Administration software is utilized for the system administrator to maintain the XID traffic management system. Preferably, the system administration software utilized a web-based interface to provide easier access and increased flexibility. There is, however, no limitation preventing the administration software from being implemented as a standalone software application. The web based administration software may run on a dedicated computer or one of the servers facilitating executing of the traffic management system.

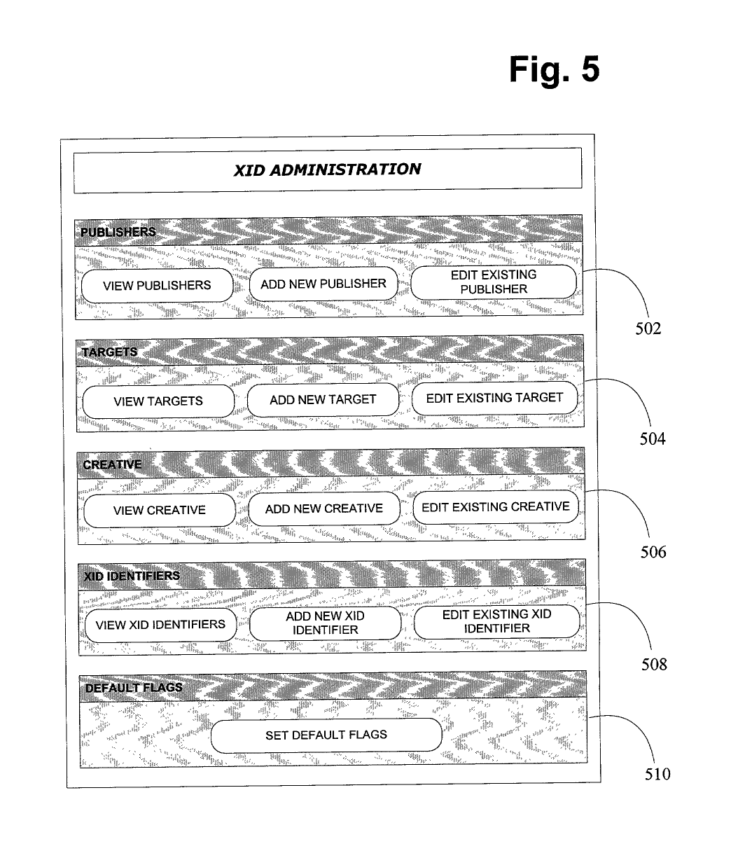

FIG. 5 is a screen shot presenting the main system administration page of the web based system administration software. Preferably, the web server hosting the system administration software includes password protection to prevent an unauthorized user from accessing the system and modifying values stored in the system database. The main administration page contains a plurality of links to controls that modify existing or generate new XID data elements. In the exemplary interface provided, view, creation and edit controls are provided for publisher 502, targets 504, creatives 506, XID identifiers 508, and default flags 510. Selecting a control instructs the web server hosting the administrative software to load the particular page identified by the control.

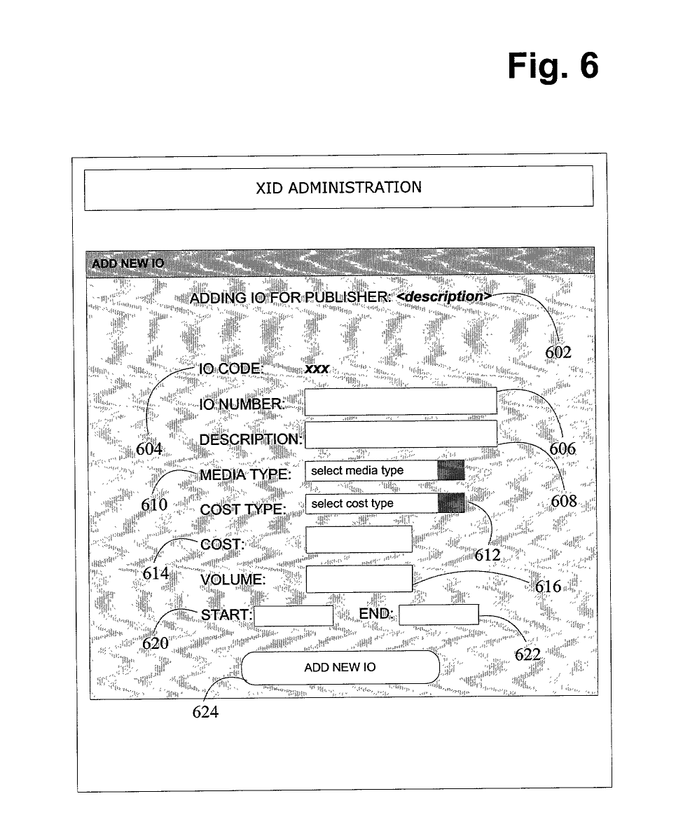

FIG. 6 presents the administration page loaded by the web server in response to selecting the “add new IO code” control. The header of the page displays the publisher that is associated with the IO code that is being added 602. The IO code sequentially assigned by the system is displayed below the publisher identifier 604. For record keeping purposes, the page also displays an IO number if one is on the insertion order provided by the inventory source 606. The IO number 606 is followed by a text entry box where the system administrator can add a description of the IO code 608.

The next element displayed on the page by the administration software is a media type drop down selection tool 610. The choice of options is stored by the system as a single character code, although multicharacter codes fall within the scope of the invention. A drop down selection tool is also provided to indicate the cost type associated with the newly created IO code 612. A text entry tool is also provided to indicate cost information in relation to cost type 614. For example, if cost type CPA is selected, cost is entered as a function of dollars per acquisition. If CPM is selected, cost is entered as a function of dollars per thousand impressions. This field preferably allows decimal values. Controls for volume 616, start date 620 and end date 622 are provided. Upon completion of the form, the administrator selects the “add new IO” control which instructs the system to write the data to the system database 624.

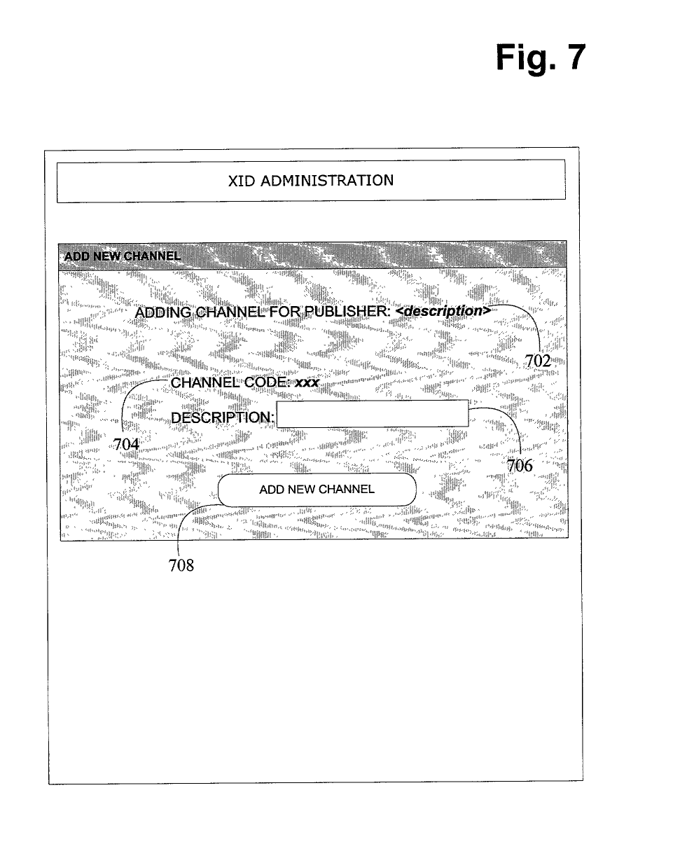

FIG. 7 presents the administration page loaded by the web server in response to selecting the “add new channel code” control. The page contains a description if the publisher under which the channel is to be added 702. This is followed by a channel code that is sequentially assigned by the system 704 and a description of the channel 706. Upon completion of the form, the administrator selects the “add new channel” control, which instructs the system to write the data to the system database 708.

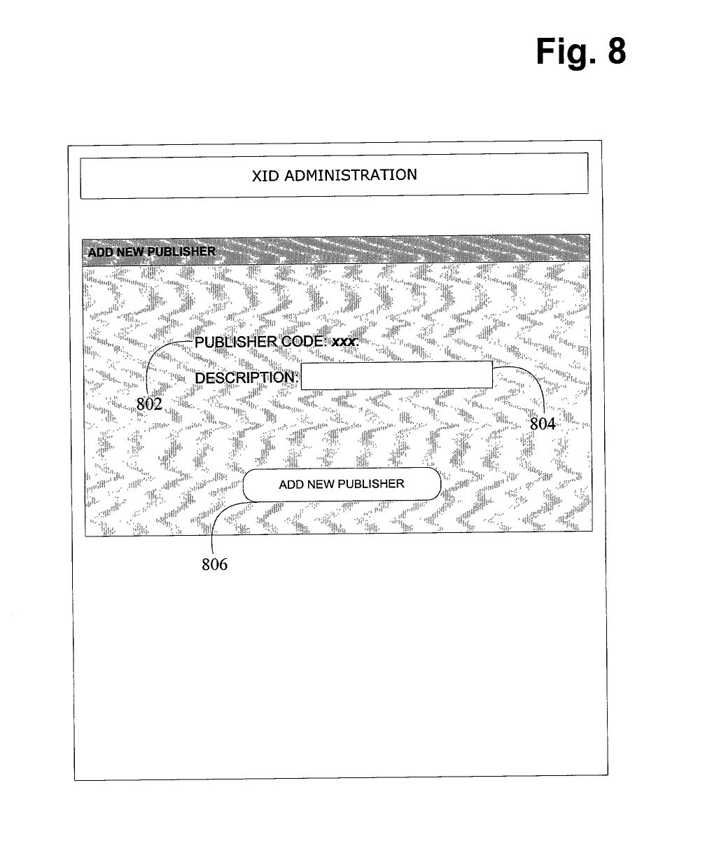

FIG. 8 presents the administration page loaded by the web server in response to selecting the “add new publisher code” control. The page contains a publisher code sequentially assigned by the system 802 as well as a description of the publisher 804. Upon completion of the form, the administrator selects the “add new publisher” control, which instructs the system to write the data to the system database 806.

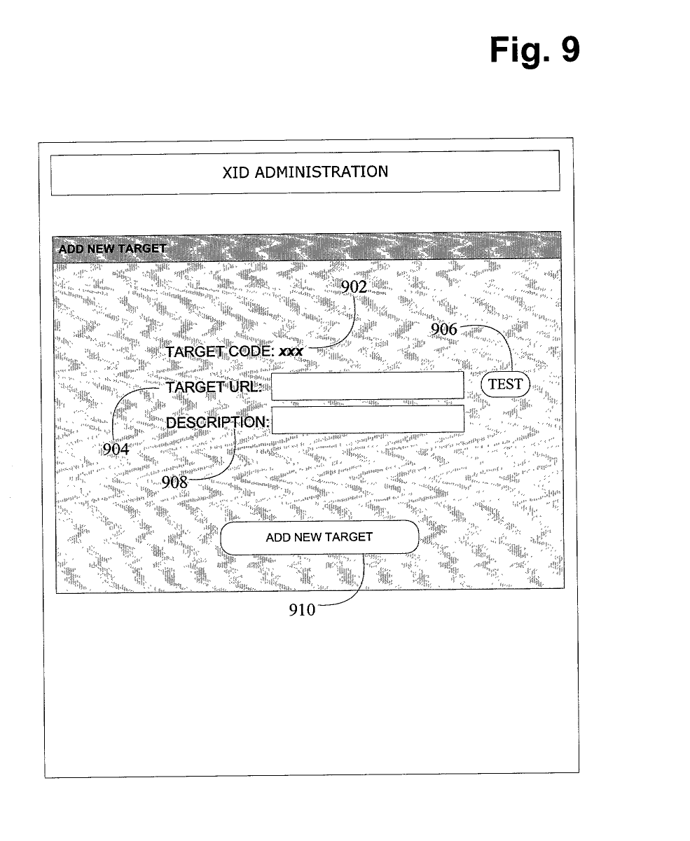

FIG. 9 presents the administration page loaded by the web server in response to selecting the “add new target code” control. The page contains a target code sequentially assigned by the system 902. The page also presents a text entry control for providing the target URL 904. Situated alongside the target URL text entry box 904 is a “test” control 906. An entry box is also provided for a description 908. Selecting the test control 906 instantiates a new browser window where the target URL is loaded to verify that the destination is correct and functioning properly. Upon completion of the form, the administrator selects the “add new target” control 910, which instructs the system to write the data to the system database.

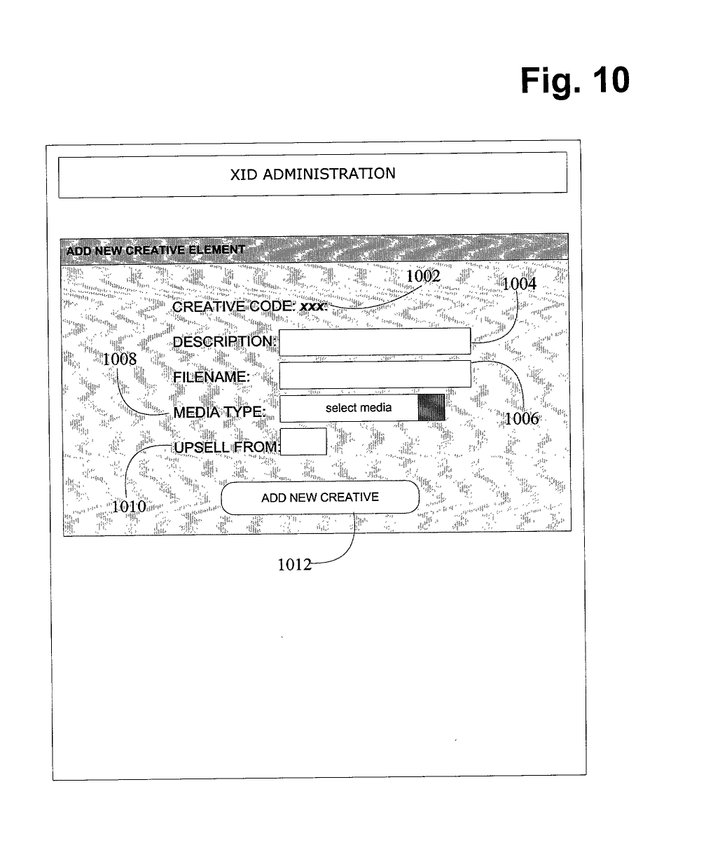

FIG. 10 presents the administrative page loaded by the web server in response to selecting the “add new creative element code” control. The page contains a creative code sequentially assigned by the system 1002. Description 1004 and filename 1006 fields are provided to describe and track the creative being entered into the system, the filename text entry control is not necessarily required to reference an actual file. A media type drop down selection tool is presented to allow the administrator to associate the newly tracked creative with its media type 1008. The selections presented by the system are stored on the database as single character codes, although multicharacter codes can easily be substituted. Exemplary media type options include, but are not limited to, banner advertisements, email, text, checkboxes, exit pop-ups, interstitials, and upsells. An “upsell from” text entry tool is provided to allow a creative identified as an upsell to be associated with the target code of the campaign that the upsell is coming from, otherwise it may be left unentered 1010. Upon completion of the form, the administrator selects the “add new creative” control 1012, which instructs the system to write the data to the system database.

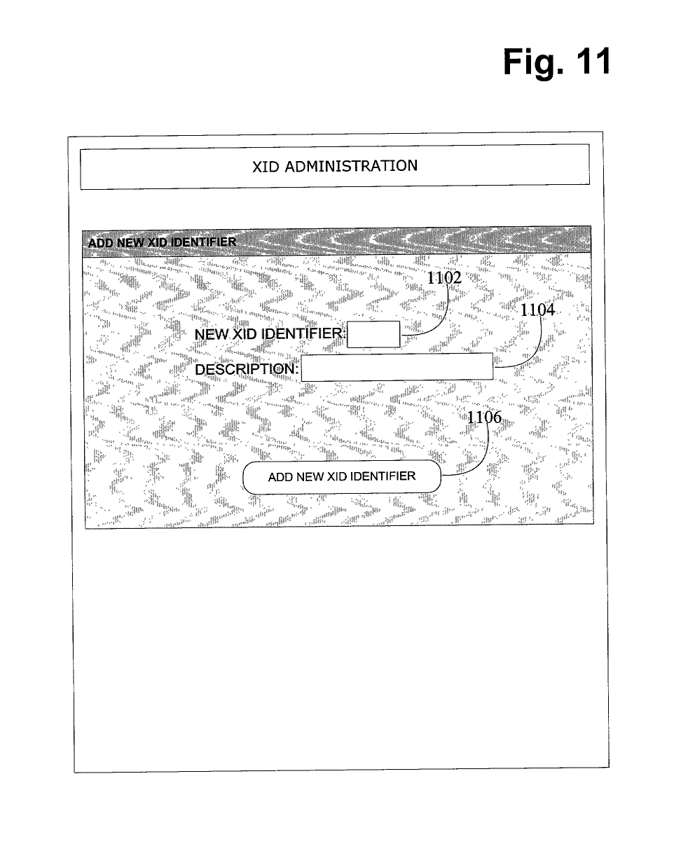

FIG. 11 presents the administrative page loaded by the web server in response to selecting the “add new XID identifier” control. The page contains a text entry tool that allows the administrator to generate a new XID identifier 1102. Because this value is not sequentially generated by the system, a check is performed by the system database when the “add new XID identifier” 1106 is selected where a query is executed on the system database to ensure duplicate XID identifiers are not being stored by the system. Finally, a description text entry field 1104 is provided to allow a description of the newly generated XID identifier to be stored in the system database. Upon completion of the form, the administrator selects the “add new XID identifier” control 1106, which instructs the system to write the data to the system database.

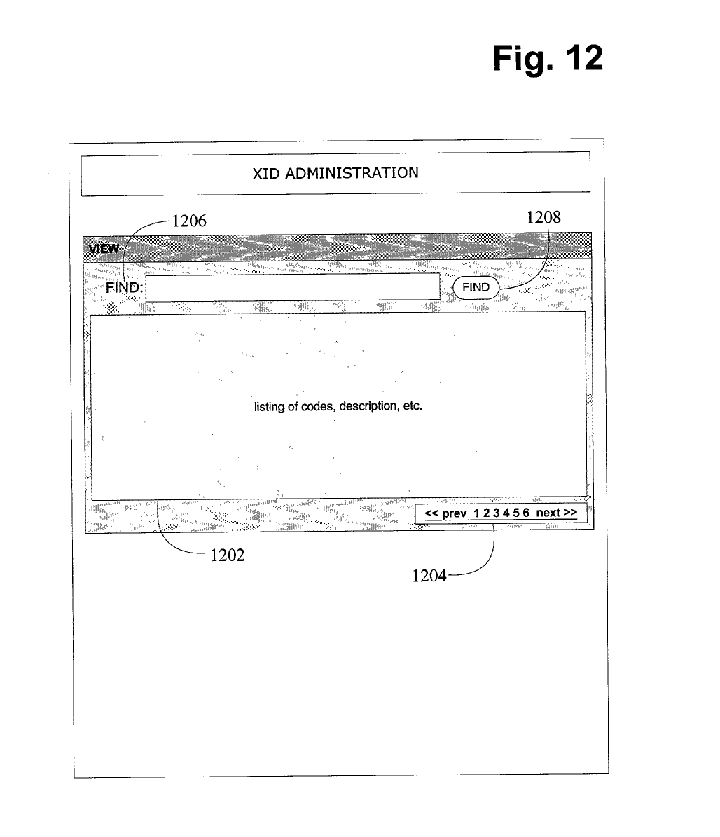

FIG. 12 presents a view tool utilized by the system to present all values stored in the system database for each type of code supported by the XID traffic management system. For example, the view tool is available to view codes and associated data for target, channel, IO, creative, and XID identifier codes. Occupying the majority of the viewable area is a listing panel 1202. Depending on the code type currently being viewed, the system executes a query and returns all codes of the desired code type (and associated data) for presentation in the listing panel 1202. Where the number of values returned by the query exceed the viewing area provided by the listing pane 1202, additional pages of data can be viewed through the use of the page turning tool 1204. If all the data returned by the system in response to the query are stored in a buffer, the page turning tool 1204 simply fetches the next page of data for display.

Alternatively, the page turn tool 1204 executes one query for each page, limiting the result set of each query to the number of values that the listing panel 1202 is capable of presenting. A find tool 1206 is provided to perform string matching on the result set returned by the system. Selecting the find control 1208 executes a text matching algorithm that takes the value provided to the find tool 1206 and the result set returned by the query as parameters. After executing the find tool, the values displayed by the listing panel 1202 are limited to only those that contain data matching the value provided by the administrator.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for directing web site traffic, the method comprising:
receiving a code encoded as a parameter to an address at a redirection server associated with the address, the code associated with one or more data values;
processing the one or more data values at the redirection server based on the code to determine a destination content page; and
directing a user to the destination content page in accordance with at least one of the one more processed data values.

2. The method of claim 1, wherein receiving the code comprises receiving the code at a redirection server comprised of one or more distributed components.

3. The method of claim 1, wherein receiving the code comprises receiving an XID code encoded as a parameter to a URL address.

4. The method of claim 1, wherein receiving the code comprises receiving a multi-part code comprised of a plurality of parts.

5. The method of claim 4, wherein processing the data values at the redirection server comprises:
selecting one or more data values associated with a given part of the code;
tracking the selection of the one or more data values associated with the given part of the code; and
calculating marketing information based on the tracking of the selection of the one or more data values associated with the given part of the code.

6. The method of claim 5, comprising associating the given part of the code with a member selected from a group consisting of a target code, a source identification code, a creative code, an insertion order code, and a specialized functionality code.

7. The method of claim 6, comprising encoding the parameter of the address with the given part of the code.

8. The method of claim 6, comprising:
checking the given part of the code for errors at the redirection server; and
if an error is identified, associating an erroneous part of the code with a default data value.

9. The method of claim 6, comprising delimiting the given part of the code by at least one separator.

10. The method of claim 6, wherein associating the given part of the code with the specialized functionality code comprises associating the given part of the code with at least one of a site redirection code and a log redirection code.

11. The method of claim 6, wherein associating the given part of the code with a member selected from a group consisting of a target code, a source identification code, a creative code, an insertion order code, and a specialized functionality code, comprises associating the given part of the code via a web-based interface.

12. The method of claim 6, wherein associating the given part of the code with the source identification code comprises associating the given part of the code with both a publisher code and a channel code.

13. The method of claim 6, wherein processing the data values comprises calculating marketing information based on a one or more data values associated with the source identification code.

14. The method of claim 6, wherein associating the given part of the code with the creative code comprises associating the given part of the code with at least one of a banner, a text link, a checkbox, an EPU, an interstitial, and an upsell.

15. The method of claim 6, wherein associating the given part of the code with the insertion order code comprises associating the given part of the code with at least one of a cost per acquisition, a cost per click, and a cost per thousand impressions.

16. The method of claim 6, wherein associating the given part of the code with the insertion order code comprises associating the given part of the code with at least one of a web-interface-defined cost per acquisition, a web-interface-defined cost per click, and a web-interface-defined cost per thousand impressions.

17. The method of claim 6, wherein processing the data values at the redirection server comprises determining if the target code is fixed, random, or optimized.

18. The method of claim 17, comprising directing the user to a pre-defined destination content page when the target code comprises a fixed target code.

19. The method of claim 17, comprising directing the user to a random one of a plurality of pre-defined destination content pages when the target code comprises a random target code.

20. The method of claim 17, comprising directing the user to one of a plurality of destination content pages in accordance with a mathematical function when the target code comprises an optimized target code.

21. The method of claim 20, wherein directing the user to the one of the plurality of destination content pages in accordance with the mathematical function comprises:
associating the insertion order code with one or more data values representative of at least one of a cost per acquisition, a cost per click, and a cost per thousand impressions; and
choosing the mathematical function from a plurality of mathematical functions based on the data values associated with the insertion order code.

22. The method of claim 17, comprising directing the user to the destination content page in accordance with the at least one or more of the data values associated with the target code.

23. The method of claim 17, comprising:
directing the user to at least one intermediary page containing an offer;
if the user accepts the offer, directing the user from the at least one intermediary page to a transaction page; and
if the user declines the offer, directing the user from the at least one intermediary page to the destination content page in accordance with at least one of the data values associated with the target code.

24. The method of claim 17, wherein receiving the code comprises:
receiving the code in a compressed format; and
decompressing the code in a compressed format at the redirection server.

25. The method of claim 24, wherein receiving the code in a compressed format comprises receiving a checksum identifier.

26. A method for directing web site traffic, comprising:
receiving a multi-part code at a redirection sever, the redirection server maintaining data values associated with one or more parts of the code;
processing the data values based on the multi-part code; and
directing a computer user to a content page in accordance with at least one of the processed data values.

27. The method of claim 26, where processing the data values at the redirection server comprises:
tracking the processing of data values associated with at least one part of the code;
calculating marketing information based on processing of the data values.

28. The method of claim 26, comprising associating the data values with at least one part of the code via a web-based interface.

29. A system for directing web site traffic, the system comprising:
a redirection server associated with an address and comprising a processor and at least one database; and
wherein the redirection server receives a code representative of one or more data values encoded as a parameter to the address, processes the one or more data values based on the code to determine a destination content page, and directs a user to the destination content page in accordance with at least one of the one or more processed data values.

30. The system of claim 29, wherein the redirection server is comprised of one or more distributed components.

31. The system of claim 29, wherein the code comprises an XID code and the address comprises a URL.

32. The system of claim 29, wherein the code comprises a plurality of parts.

33. The system of claim 32, wherein the redirection server selects one or more of the data values associated with a given part of the code, tracks the one or more data values associated with the given part of the code, and calculates marketing information based on the tracking of the selection of the one or more data values associated with the given part of the code.

34. The system of claim 33, wherein the redirection server associates the given part of the code with a member selected from a group consisting of a target code, a source identification code, a creative code, an insertion order code, and a specialized functionality code.

35. The system of claim 34, wherein at least one of the redirection server and a first web site computer encodes the parameter of the address with the given part of the code.

36. The system of claim 34, wherein the redirection server checks the given part of the code for errors and, if an error is identified, associates an erroneous part of the code with a default data value.

37. The system of claim 34, wherein the given part of the code is delimited by at least one separator.

38. The system of claim 34, wherein the specialized functionality code comprises at least one of a site redirection code and a log redirection code.

39. The system of claim 34, comprising a web-based interface operative to associate the given part of the code with at least one or more data values.

40. The system of claim 34, wherein the source identification code comprises a publisher code and a channel code.

41. The system of claim 34, wherein the redirection server calculates marketing information based on a one or more data values associated with the source identification code.

42. The system of claim 34, wherein the given part of the code is associated with the creative code and is associated with at least one of a banner, a text link, a checkbox, an EPU, an interstitial, and an upsell.

43. The system of claim 34, wherein the given part of the code is associated with the insertion order code and is associated with at least a one of a cost per acquisition, a cost per click, and a cost per thousand impressions.

44. The system of claim 34, comprising a web-interface operative to associate the insertion order code with at least one of a cost per acquisition, a cost per click, and a cost per thousand impressions.

45. The system of claim 34, wherein the redirection server determines if the target code is fixed, random, or optimized.

46. The system of claim 45, wherein the redirection server directs the user to a pre-defined destination content page when the target code comprises a random fixed code.

47. The system of claim 45, wherein the redirection server directs the user to a random one of a plurality of pre-defined destination content pages when the target comprises a random target code.

48. The system of claim 45, wherein the redirection server directs the user to a destination content page in accordance with a mathematical function when the target code comprises an optimized target code.

49. The system of claim 48, wherein the redirection server associates the insertion order code with one or more data values representative of at least one of a cost per acquisition, a cost per click, and a cost per thousand impressions, and wherein the redirection server chooses the mathematical function from a plurality of mathematical functions based on the one or more data values associated with the insertion order code.

50. The system of claim 45, wherein the redirection server directs the user to the destination content page in accordance with at least one of the one or more data values associated with the target code.

51. The system of claim 45, wherein the redirection server:
directs the user to at least one intermediary page containing an offer;
if the user accepts the offer, directs the user from the at least one intermediary page to a transaction page; and
if the user declines the offer, directs the user from the at least one intermediary page to the destination content page in accordance with at least one of the one or more data values associated with the target code.

52. The system of claim 45, wherein the redirection server receives the code in a compressed format and decompresses the code in a compressed format.

53. The system of claim 52, wherein the compressed code comprises a checksum identifier.
